(19) United States
(12) Patent Application Publication
(10) Pub. No.: US 2010/0325543 A1
(43) Pub. Date: Dec. 23, 2010

(54) Media Player Architecture and Methods

(76) Inventors: Scott Williams, San Anselmo, CA (US); James Skinner, Singapore (SG); Douglas Weber, Salt Lake City, UT (US); Matthew Maxwell, Saratoga Springs, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/490,254

(22) Filed: Jun. 23, 2009

(51) Int. Cl. G06F 3/01; G06F 3/048

(52) U.S. Cl. 715/716; 715/810

(57) ABSTRACT

A media player for playing files of different formats on demand using a plurality of renderer components appropriate for the different formats for a network-connected computer system or electronic device having a visual display includes a media player shell having a viewable stage area displayed on the visual display for playing media and for displaying any controls for controlling playing of media. The shell determines file formats of files to be played by the media player and downloads renderer components capable of playing the file formats. Each renderer component is downloaded by the shell on demand and displayed on the stage area, where it is used to play the file. When more than one file is to be played by the player, the shell determines this fact first downloads a document chooser to be displayed in the stage area for selecting files for playing.

### BACKGROUND OF THE INVENTION

1. Field of the Invention

The present invention relates to network-based delivery of content to a viewer or player, and more particularly to an architecture for efficiently implementing a viewer or player capable of customization and capable of providing access to a variety of content file types.

2. Background and Related Art

Computer networks, including networks of sizes from local to worldwide (such as the Internet) have provided new mechanisms to distribute information and media from one person or user to another. However, the distribution over networked computers has been limited in many regards. For example, while many different file and media types, including static and dynamic content, can be distributed over networks, current systems are limited in their ability to seamlessly display or otherwise provide access to the multiple file types.

For instance, a user accessing an audio file is typically required to utilize a media player specifically configured to play the desired audio file type. Some audio file types are proprietary, and can only be accessed using certain types of players. If the user decides to switch to accessing (i.e. viewing) a video file, the user typically must switch to a player designed to play video files of the type the user desires to view. If the user then decides to view a portable document format (PDF) file, the user then has to switch to a viewer capable of displaying the PDF file. Nearly endless examples could be provided, but similar difficulties are encountered when switching between word processor documents and files, spreadsheet documents and files, slideshow presentation files, still graphical files, enriched-content files, etc., in addition to the other types of files discussed above.

One difficulty presented by currently-available solutions and the various types of files that can be distributed over networks is that each of the various players or viewers necessary to view or otherwise access the various file types must all be installed and available on a computer before the files can be accessed, played, or viewed. It is fairly common for a user to desire to access a particular file only to discover that access is not possible without first downloading and installing a particular viewer, player, or other application over the network or installing a particular viewer, player, or other application from some form of storage media. Even the installation of the necessary players/viewers can present problems: large numbers of players/viewers installed on a system take up valuable resources; as the number of viewers/players installed on a particular computer system increases, the potential for undesirable interactions between programs increases; and the various viewers/players can interfere with each other in undesirable ways, such as by competing with each other to be the designated program to open a particular file type.

Even if a particular viewer is capable of displaying files of multiple types, this viewer does not address all problems with the distribution and access of files over a network. For example, the download size or installation size of a viewer capable of displaying a broad array of file types may be larger than desired because of the multiple renderers that are downloaded or installed, regardless of whether the particular file or files to be viewed/accessed at a particular time are limited. For example, if a user only wishes to view still images during a particular session or time period, it may be wasteful to install and have available renderers within a viewer capable of displaying or playing video and audio files, or renderers capable of displaying textual documents, spreadsheets, or the like.

These problems may be exacerbated during network-based delivery of files and information. For example, a number of files may be delivered to a user in a single session, and those files may include files of various types. Using currently-available players/viewers, the transition between files may be difficult and interrupted at best, as a different player/viewer must be initialized and used to display the each different file type. Even when several of the files are of the same type, player/viewer changes may be just as frequent based on the order the files are presented: if two files of one type are divided by a file of another type, transitions are still necessary. At worst, the user experience can be highly frustrating, as installation of additional viewers/players is required. Thus, currently available systems have proven unsatisfactory at meeting user expectation: when viewing files over a network, such as using a browser, users have come to expect a seamless and uninterrupted experience.

Many of these problems even continue when accessing files previously-obtained over a network or by other means and being viewed locally. Therefore, the currently-available systems and services for distribution of files over networks are limited.

### BRIEF SUMMARY OF THE INVENTION

Implementation of the invention provides a media player for playing files of different formats on demand using a plurality of renderer components appropriate for the different formats for a network-connected computer system or electronic device having a visual display. The media player includes a media player shell having a viewable stage area displayed on the visual display for playing media and for displaying any controls for controlling playing of media. The shell determines a file format of one or more files to be played by the media player and downloads a first renderer component capable of playing the file format. The first renderer component is one of a plurality of downloadable renderer components, each providing access to a different file format. Each renderer component is downloaded by the shell on demand and is displayed on the stage area, where it is used to play the file.

Thus, implementation of the invention provides, in a network-connected computer system or electronic device having a visual display, a method for providing a media player for playing files of different formats on demand using a plurality of renderer components capable of playing the different formats. The method includes providing a media player shell displayed on a visual display of a network-connected computer system or electronic device. The shell has a viewable stage area for playing media and for displaying any controls for controlling playing of media. The shell receives a manifest that provides the shell information related to playing of one or more files to be played by the media player, including how many files are to be made available for playing in the media player; and the file format or formats of each of the files. The shell then determines a first file format of a first file to be played by the media player, downloads a first renderer component capable of playing the first file format, and displays the first renderer component on the stage area. Thereafter, the media player downloads and plays the first file using the first renderer component.

When more than one file is to be played by the player, the shell determines this fact from the manifest and first downloads a document chooser. Various different document choosers may be available, and the document chooser downloaded may be selected based on the constituent files to be displayed in the player. The document chooser is displayed in the stage area and permits a user of the media player to select files for playing. Any time the user selects a file for playing having a format for which the shell has not yet downloaded a compatible renderer component, the shell first downloads a compatible renderer component and displays it in the stage area, then downloads and plays the file using the new renderer component. Alternatively, or additionally, the system may be configured to download multiple renderer components at one or more times before a file using the renderer components has been selected for viewing. For example, all renderer components that will be used for a given set of files to be played may be downloaded immediately before playing any files or renderer components may be downloaded using additional download bandwidth while a file is being downloaded for playing or is being played. As another example, new renderer components may be downloaded in anticipation of a next file to be selected in a given set or list of files to be played.

Regardless of when the other renderer components are downloaded, the act of displaying a different renderer component may effectively hide one or more previously-displayed renderer components. Hidden renderer components may be retained in local memory whereby they do not need to be downloaded again when any files having formats that have been previously played (including the previously-played file or files) are selected for playing.

Thus, implementation of the invention provides a media player capable of playing a wide variety of file types without requiring that the media player be previously installed and capable of handling every possible file type in advance. Instead, renderer components are installed as needed, thereby limiting the download and install time and effectively increasing the speed of access to files of various types over a network while still providing a single unified media player for playing the different types of files. Additionally, implementation of the invention provides for the selection of a file chooser based on the nature of the files to be played.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative system for use with embodiments of the invention;

FIG. 2 shows a representative network system for use with embodiments of the invention;

FIG. 3 shows a depiction of various components of an embodiment of a media player;

FIG. 4 depicts a large format version of an embodiment of a media player shell;

FIG. 5 depicts a small format version of an embodiment of a media player shell;

FIG. 6 depicts an embodiment of a document selector for use with a media player;

FIG. 7 shows one embodiment of an audio renderer;

FIG. 8 shows an alternate embodiment of an audio renderer;

FIG. 9 shows one embodiment of a video renderer;

FIG. 10 shows an embodiment of an image renderer;

FIG. 11 shows an embodiment of a document viewer;

FIG. 12 depicts an embodiment of a media player having a document chooser and an audio renderer;

FIG. 13 depicts an alternate embodiment of a media player having an audio renderer;

FIG. 14 depicts an embodiment of a media player having a document chooser and a video renderer;

FIG. 15 depicts an embodiment of a media player having a document chooser and an image renderer;

FIG. 16 depicts an embodiment of a media player having a document chooser and a document viewer;

FIG. 17 depicts an embodiment of a media player having a document viewer and no document chooser; and

FIG. 18 shows a graphical depiction of a publication manifest for providing a media player with information about a publication containing several documents.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide a media player for playing files of different formats on demand using a plurality of renderer components appropriate for the different formats for a network-connected computer system or electronic device having a visual display. The media player includes a media player shell having a viewable stage area displayed on the visual display for playing media and for displaying any controls for controlling playing of media. The shell determines a file format of one or more files to be played by the media player and downloads a first renderer component capable of playing the file format. The first renderer component is one of a plurality of downloadable renderer components, each providing access to a different file format. Each renderer component is downloaded by the shell on demand and is displayed on the stage area, where it is used to play the file.

Thus, embodiments of the invention provide, in a network-connected computer system or electronic device having a visual display, a method for providing a media player for playing files of different formats on demand using a plurality of renderer components capable of playing the different formats. The method includes providing a media player shell displayed on a visual display of a network-connected computer system or electronic device. The shell has a viewable stage area for playing media and for displaying any controls for controlling playing of media. The shell receives a manifest that provides the shell information related to playing of one or more files to be played by the media player, including how many files are to be made available for playing in the media player; and the file format or formats of each of the files. The shell then determines a first file format of a first file to be played by the media player, downloads a first renderer component capable of playing the first file format, and displays the first renderer component on the stage area. Thereafter, the media player downloads and plays the first file using the first renderer component.

When more than one file is to be played by the player, the shell determines this fact from the manifest and first downloads a document chooser. Various different document choosers may be available, and the document chooser downloaded may be selected based on the constituent files to be displayed in the player. The document chooser is displayed in the stage area and permits a user of the media player to select files for playing. Any time the user selects a file for playing having a format for which the shell has not yet downloaded a compatible renderer component, the shell first downloads a compatible renderer component and displays it in the stage area, then downloads and plays the file using the new renderer component. Alternatively, or additionally, the system may be configured to download multiple renderer components at one or more times before a file using the renderer components has been selected for viewing. For example, all renderer components that will be used for a given set of files to be played may be downloaded immediately before playing any files or renderer components may be downloaded using additional download bandwidth while a file is being downloaded for playing or is being played. As another example, new renderer components may be downloaded in anticipation of a next file to be selected in a given set or list of files to be played.

Regardless of when the other renderer components are downloaded, the act of displaying a different renderer component may effectively hide one or more previously-displayed renderer components. Hidden renderer components may be retained in local memory whereby they do not need to be downloaded again when any files having formats that have been previously played (including the previously-played file or files) are selected for playing.

Thus, embodiments of the invention provides a media player capable of playing a wide variety of file types without requiring that the media player be previously installed and capable of handling every possible file type in advance. Instead, renderer components are installed as needed, thereby limiting the download and install time and effectively increasing the speed of access to files of various types over a network while still providing a single unified media player for playing the different types of files. Additionally, embodiments of the invention provide for the selection of a file chooser based on the nature of the files to be played.

In the specification and in the claims, the terms “play,” “playing,” “played” or any other form thereof shall be interpreted to mean any method by which a media player or component thereof may provide access to a file, including visual display of textual files, spreadsheets, and similar documents, visual display of images, slideshows, and the like, audio rendering of audio files, video and/or audiovisual rendering of video/motion files, or any other type of file access, including interactive rendering and other forms of access involving user input.

Where consistent, the use of the terms “document” and “file” herein should be considered interchangeable and each use of either term should be considered to embrace alternatively the other term.

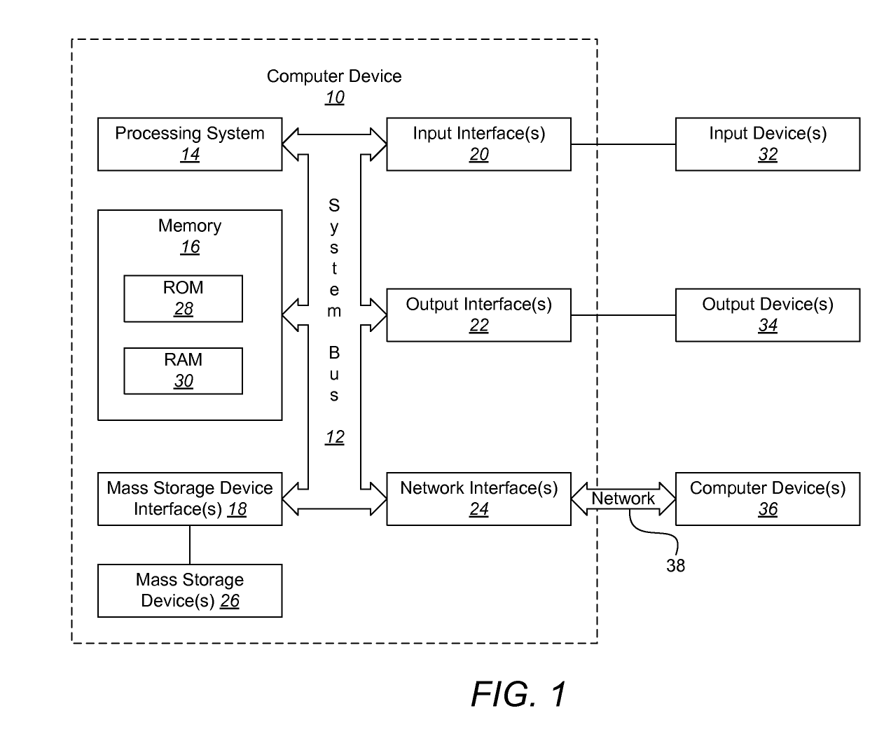

As embodiments of the invention embrace a network-connected computer system or electronic device having a visual display, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices 34 include a monitor, a display screen, electronic paper or an e-ink display of a computer device or consumer electronic device, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

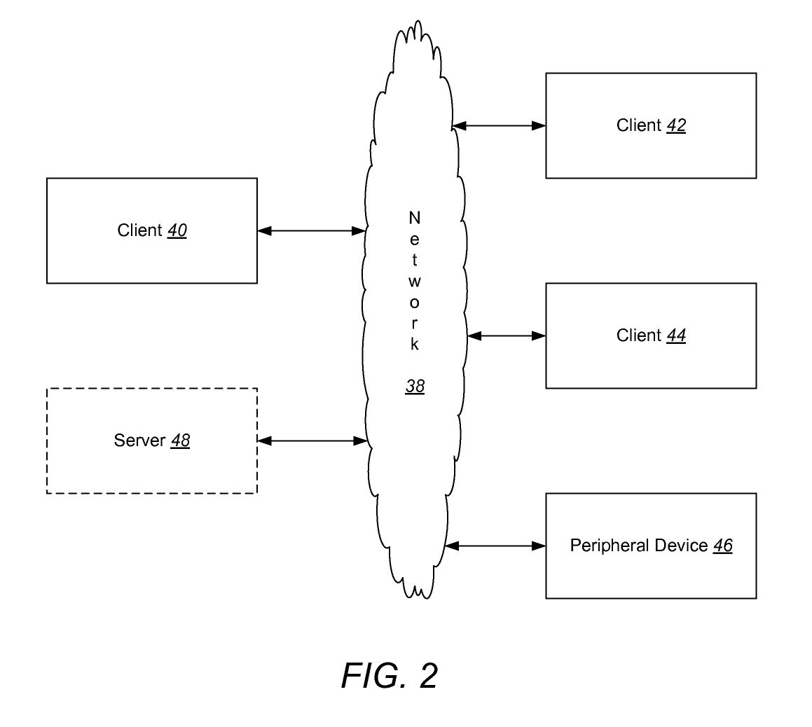

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Embodiments of the invention provide an efficient architecture for efficiently implementing a multimedia player, including efficient loading of necessary renderers or renderer components, provision of a document chooser for selection of files for playing, and efficient transmission of information regarding files available for playing using a manifest. This provides a better user experience in terms of loading speeds and selection of files for viewing. The media player may thus be considered an omni-player, because it is able to play files of multiple formats instead of requiring multiple players, one for each format. All files are played within a shell of the media player on a stage area of the shell.

The media player or multimedia player is capable of playing “publications,” which are groups of one or more individual documents, files, and/or other publications. A document could be a video (e.g. a Flash video .flv), an audio song, podcast, or other recording (e.g. an .mp3 file), a photograph or image (e.g. .jpg or .png), a text document, a spreadsheet, a slideshow, a presentation, an interactive lesson, or any other file type. Each publication may include a single document, file or other publication, or may include multiple documents, files, or other publications. An all-music publication might contain all .mp3 documents. As another example, a photo album publication might contain all image documents, of a single image type or of varying image types. A mixed-media publication contains documents of different types. For example, one mixed-media publication may contain some text documents, some images, and some video files, while another may contain some audio files and some images.

The media player learns about the publication it will display by accessing a “publication manifest.” The manifest may instruct the player as to whether or not the publication is a single-document publication, a multiple-document publication, and/or whether the publication includes other publications. The manifest may also tell the media player the name of the publication, what media types it contains (video, audio, image, and/or document, etc.), and in some embodiments a “download URL” a user can use to access and download the entire publication.

Once the media player accesses the publication manifest, it determines whether a “document chooser” is desirable. A document chooser is a media player component that allows a user of the media player to choose between different documents, files, or publications in the publication. Thus, if the publication is a single-document publication, there is no need to show the user a document chooser. In some embodiments, different document choosers may be available depending on the types of documents, files or publications are available within a certain publication. Thus, when the media player determines that a document chooser is desirable, it also determines what document chooser to load, if multiple document choosers are available. If a document chooser is to be displayed, the player will download a component (e.g. Flash SWF file in one implementation) that contains the document chooser.

Once the document chooser component has been downloaded, the media player will “attach” the document chooser to the stage and display it to the end user. The media player will also instruct the document chooser to load a list of names, thumbnails, or other information for the documents that makes up the publication. This information may be included in the publication manifest or may be downloaded separately from the manifest. Additionally, what portion of this information is to be displayed by the document chooser may be varied depending on the types of files in the publication and/or the type of the document chooser loaded by the media player.

The media player determines a type of the first document in the list of documents forming the publication to be displayed. This first document to be displayed may be a document selected by a user using the document chooser or may be automatically displayed first by default (such as being designated a first document in the document manifest). Based on the type of the first document to be displayed (e.g. image, video, audio, or text document, etc.), the player will download a renderer component (e.g. a Flash SWF file in one implementation) that implements the “renderer” for that type of document. Once that renderer component has been downloaded, the player “attaches” it to the stage so that the user can see it.

In some embodiments, the player continues determining the types of all documents in the publication, and continues downloading the other renderer components that will be used to display the other documents in the publication. This renderer component downloading may occur simultaneously with display of the first renderer component on the stage, prior to display of the first renderer component on the stage, or after display of the first renderer component on the stage. Additionally, the continued renderer component download may occur after the media player begins playing and/or downloading the first file as described below, and may occur simultaneously with first file playing/downloading if available communication bandwidth supports such simultaneous downloading. If insufficient bandwidth is available to support simultaneous download, downloading of additional renderer components may occur at times of lesser bandwidth demand or as necessary to play selected files, as discussed below.

In some embodiments, after the first renderer component has been downloaded and attached to the stage, the player will then pass into the renderer or renderer component the information pertaining to the document to render/show. That information may include the document name, its description, the URL(s) to the file(s) that comprise the document, etc. The information pertaining to the document may be obtained from the publication manifest or may be downloaded separately.

The renderer or some other player component, such as the shell, downloads the file or files that comprise the document, and displays the document to the end user. If the document is an image, the user will see an image in the renderer. If the document is a video, the user will either see a video in a paused state—allowing the user to click play to begin viewing the video, or alternatively the video may begin playing automatically. If the document is an audio document (e.g. song or podcast), the user will see the audio player (and possibly cover art for the audio) either with the audio player in the “paused” state, or alternatively the audio may begin playing automatically. If the document is a text document, the user will see that document loaded (progressively or by streaming) into a document viewer.

If the publication contains multiple files, the user may choose a different document to view using the document chooser such as by clicking on a title or thumbnail or by operating controls to select next and previous documents. As discussed above, if the publication is a single-file publication, then there may be no document chooser from which the user can choose a document.

The document chooser to load may be selected based on the configuration of the files to display. For example, if the publication contains a single file, then no document chooser may be shown. If the publication contains all images, then a thumbnail view document chooser may be used. If text-type and other documents are contained in the publication, then file names may be shown in the document chooser. The document chooser may be varied for any file types/formats and combinations thereof, and so on. These may be configured in many different ways, and may include file names, thumbnails, previews, user ratings, and any other information that may be useful to a user in selecting a file to display.

Each time the user selects a document from the document chooser, the media player determines whether or not it has already downloaded the renderer component capable of playing that document. The media player may have already downloaded the renderer component due to a download for playing a file type of a previously-played file, due to a pre-download of the renderer component in anticipation of user selection of the document (e.g. the document is next in the list of documents), or due to a fully- or partially-complete pre-download of all renderer components. If the media player has already downloaded the capable renderer component, then the player may “hide” the currently-displayed renderer and “show” the renderer capable of playing the document just selected by the end user. If, however, the player has not yet downloaded the appropriate renderer for the document, it will do so now. Once the renderer has been downloaded, the player will “attach” it to the stage and pass into it all of the document information it requires in order to render/display the document to the end user. Alternatively, in some embodiments, multiple renderer components may be “shown” at one time in the stage area, where sufficient stage area is visible for simultaneous display of multiple renderer components.

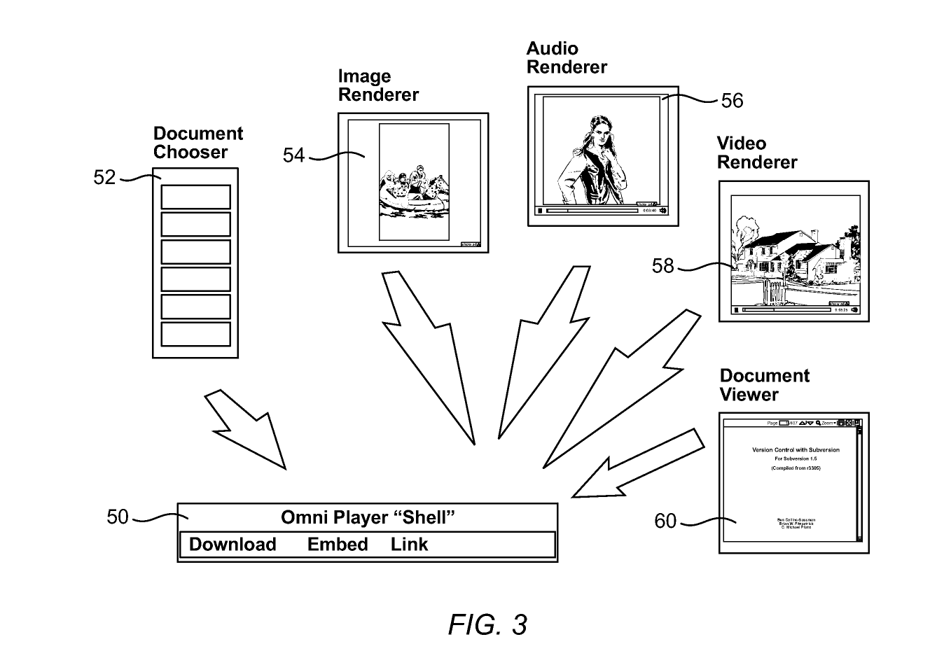

FIG. 3 provides a depiction of various components of embodiments of the media player. Such embodiments of the media player include a media player shell 50. The media player shell 50 may be of different sizes, depending on the intended use and use locations of the media player. For example, a media player may be intended for display on a web page for access by a user's browser from a full-featured computer having a large screen. In such an instance, the media player may have a relatively large area assigned to it, such as 600 pixels wide by 400 pixels tall (or any other measurement). In contrast, a media player may be intended for display embedded in a web page primarily intended for access by mobile devices, such as cell phones, having a limited display area. In such an instance, the media player may have a relatively small area assigned to it. As another example or consideration, if a media player is intended to play primarily audio files, one user may decide to provide a media player with a larger display area to permit displaying more information about the audio files (such as cover art), while another media player might be provided with only minimal information.

The media player also may include a document chooser 52, if the media player is to be capable of playing more than one files. As discussed above, multiple or many different document choosers 52 may be available, and may be selected for inclusion in the media player based on the types and number of files to be displayed in the media player. The media player also includes at least one renderer component. The renderer component may include an image renderer 54, an audio renderer 56, a video renderer 58, a document viewer 60, or other available renderer component not specifically shown. The document chooser 52, if any, and any renderer component(s) are displayed by the shell 50.

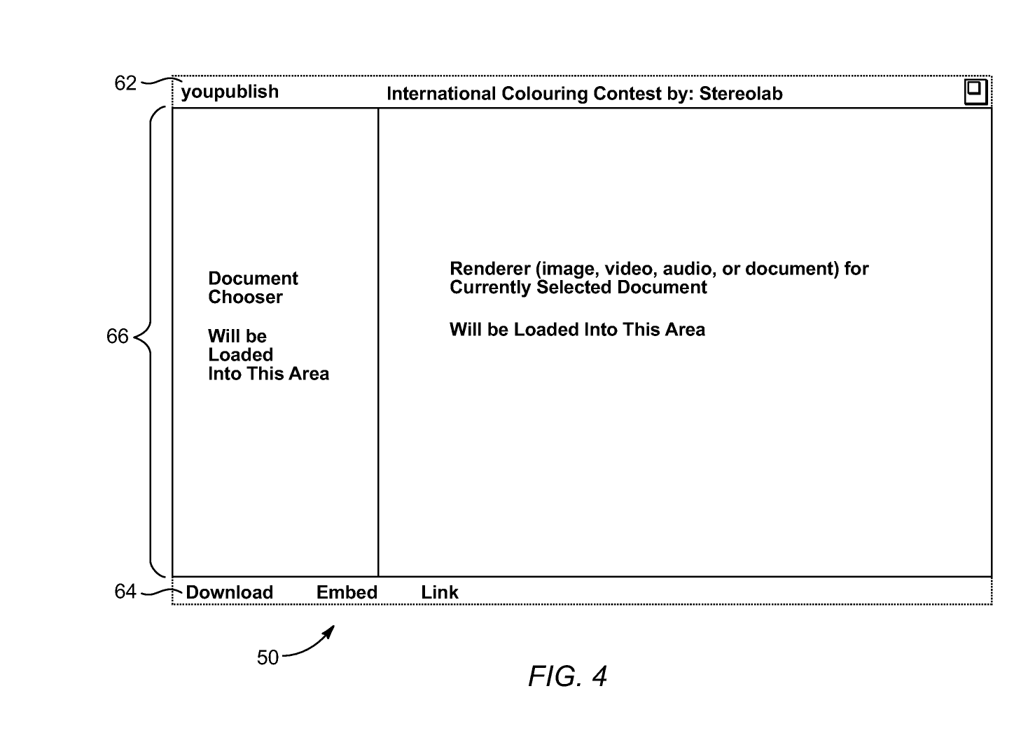

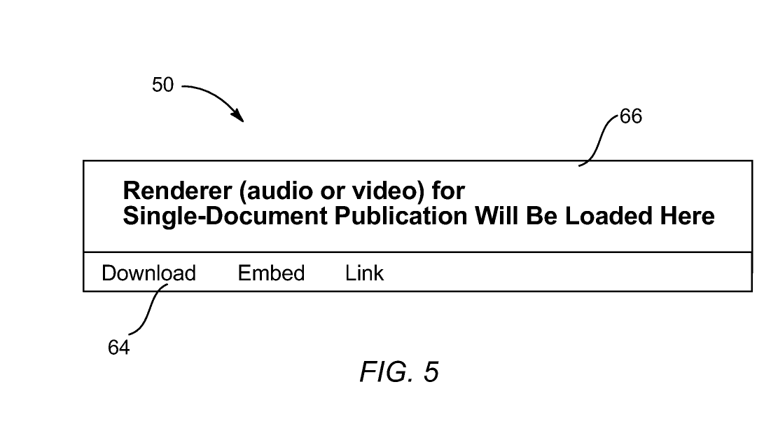

FIGS. 4 and 5 provide depictions of alternate embodiments of the shell 50. The media player shell 50 is the first part of the media player that is running in the user's browser when the user views a publication. When a web page contains the player, the player may be defined by an “embed” tag. This tag describes—among other things—how much screen real estate it can use when it is showing within the web page. The embed tag also allows the player to be embedded in one or more web sites such that a plurality of files associated with the player can be accessed from the embedded player, and may permit copying of an instance of the player from one web page to another.

The first thing that the media player does (e.g. through the shell 50) is determine how much visual real estate it has in which to display content. If it has been configured to be relatively large (for instance, 600 pixels wide by 400 pixels tall, 800 pixels wide by 600 pixels tall, etc.), then a “large form factor” version of the media player may be used—allowing the player to show the most data, a version of the document chooser 52, etc. If the embed tag describing the player only allocates it a small amount of the web page in which to display itself, a “small form factor” version of the media player will be used. The small form factor version of the player typically works well, for example, when a user wants to embed just a single song, podcast, or other audio file—and there is no real need to include much visual information.

FIG. 4 shows one embodiment of the large form factor version of the media player shell 50. The media player shell 50 includes a header 62 and a footer 64, in which information about the media player and/or the file or files being displayed can be displayed, and in which one or more links or controls may be displayed, such as links to permit embedding a copy of the media player in other pages and the like. The shell 50 also includes a stage or stage area (“stage 66”) in which the document chooser 52, if any, and any renderer components may be displayed. In contrast, FIG. 5 shows one embodiment of the small form factor version of the shell 50. This version lacks the header 62 and has a much smaller space allotted to the stage 66. Of course, it will be understood that other embodiments of the shell 50 may be provided, including large form factor embodiments without the header 62 and/or footer 64 and small form factor embodiments with the header 62 or without either of the header 62 or the footer 64. Thus, the illustrated embodiments are to be considered only illustrative and not restrictive.

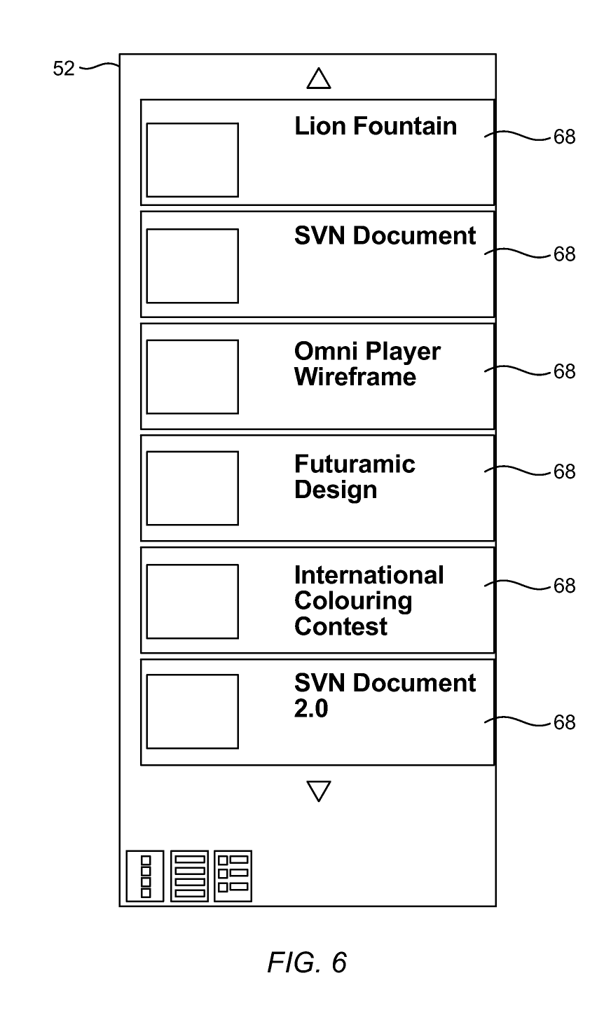

The document chooser 52 (which may also be known as the track chooser) is what the media player uses to display the list of documents within a publication, such as when more than one document is in a publication. FIG. 6 shows one embodiment of the document chooser 52. The user can click on an item 68 in this list in order to “choose” a document for viewing. The document chooser 52, like all of the renderer components, is “dynamically loaded” by the media player if the media player needs to provide a way of showing/choosing the documents of a publication. Because the document chooser 52 is dynamically loaded, different styles of the document chooser 52 can be “swapped out”—allowing the player to be “skinned” or allowing the way that users view and interact with the list of document to differ from one implementation of the document chooser 52 to another.

The document chooser 52 to be loaded may be selected based on the files to be available for playing. If the publication contains all images, then a thumbnail view document chooser 52 may be used. If text-type and other documents are contained in the publication, then file names may be shown in the document chooser 52. The document chooser 52 may be varied for any file types/formats and combinations thereof, and so on. As such, the amount of the stage 66 dedicated to the document chooser 52 may be varied depending on the document chooser 52 selected for the media player. These may be configured in many different ways, and may include file names, thumbnails, previews, user ratings, and any other information that may be useful to a user in selecting a file to display.

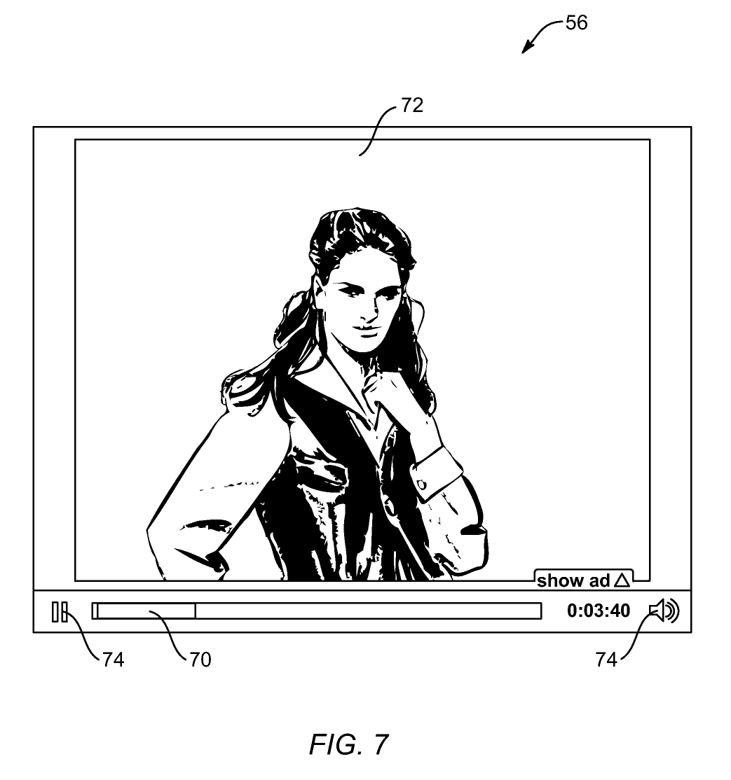

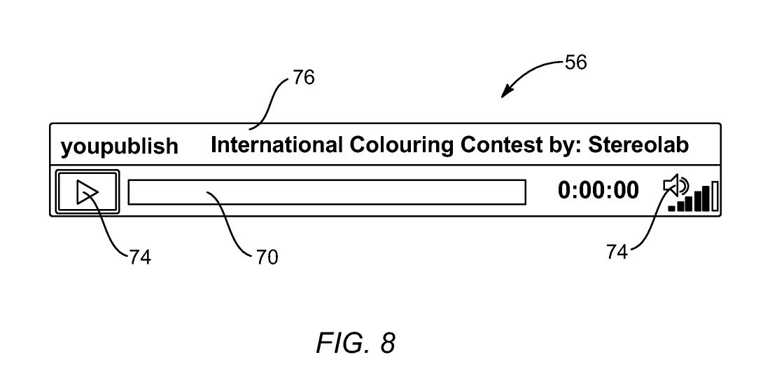

At least two different audio renderers 56 may be provided, as illustrated by FIGS. 7 and 8, namely a large form factor version (FIG. 7) and a small form factor version (FIG. 8). The media player decides which of them to load in order to render/play a song or podcast. If the media Player has sufficient room on the screen, it may load the large audio renderer 56 of FIG. 7, which may contain a progress bar 70, album art 72, and large renderer controls 74, such as a large volume control, and a play/pause button. If the media player is in a small form factor mode, it may load the small audio renderer 56 of FIG. 8. The depicted small audio renderer 56 shows no cover artwork and has a smaller progress bar 70 and renderer controls. The small audio renderer 56 may provide track or other file information in a header 76.

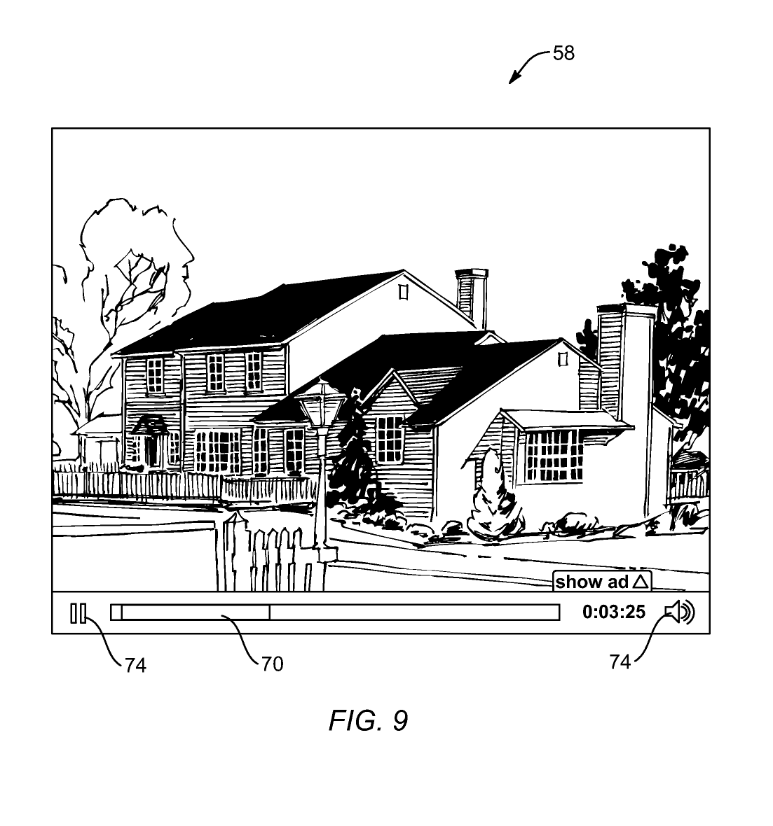

FIG. 9 shows an embodiment of the video renderer 58. The video renderer 58 shown in FIG. 9 is similar in appearance and function to the large audio renderer 56. The video renderer 58 contains renderer controls 74, such as a pause/play button, and a volume control and also includes a progress bar 70. The video renderer 58 is dynamically loaded into the media player only when it is required, just like the document chooser 52 and the audio renderer 56. Because it is dynamically loaded, there can be different versions of this component—with different “skins,” different behavior, different media formats supported, etc.

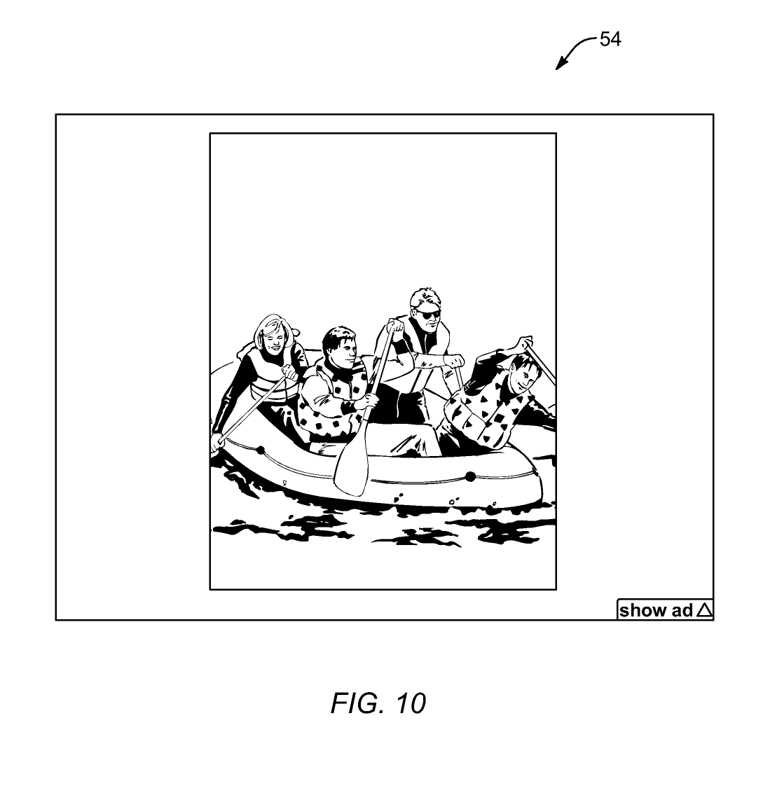

FIG. 10 shows an embodiment of the image renderer 54. The image renderer 54 has the ability to display a single image. It may support zooming and other common or special image viewer functionalities. The image renderer 54 is dynamically loaded like the other components only when it is required for playing a file. Because it is dynamically loaded, there can be different versions of this component, with different skins, different behavior, different media formats supported, etc.

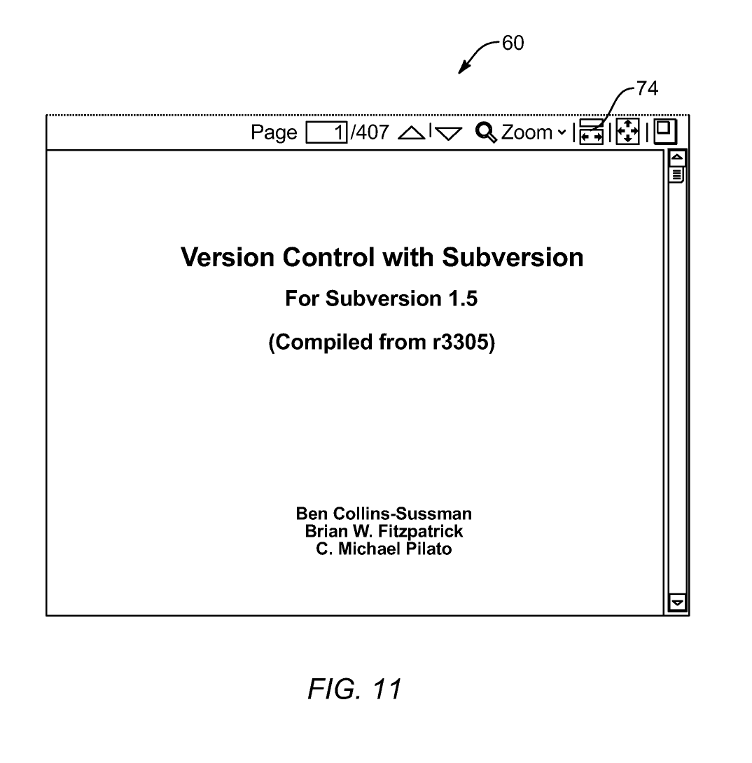

FIG. 11 shows one embodiment of the document viewer 60. It may be a sophisticated component capable of displaying documents with 1,000 pages or more, and may have renderer controls 72 for controlling viewing of the documents. The renderer controls 72 may include simple and/or complex controls, such as pagination controls, scroll bars, zoom controls, and the like. Just like the other media player components, this component is dynamically loaded into the media player when it is required for displaying a text document to the end user, and there can be different versions of the document viewer 60, as with the other renderer components.

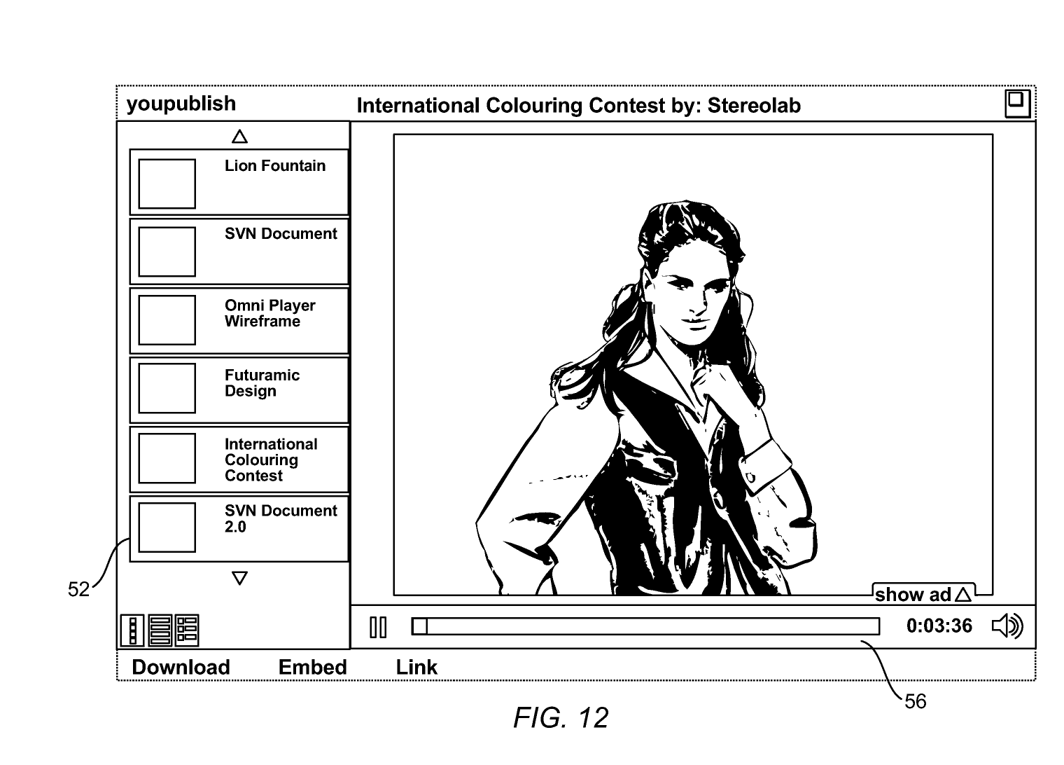

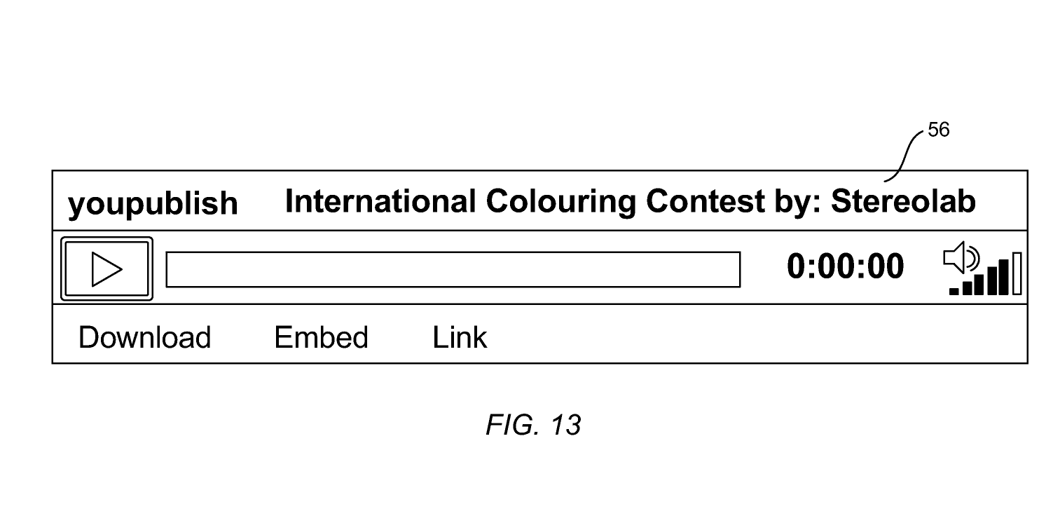

FIGS. 12-17 provide varying views of the media player with different player components loaded, showing some ways in which the media player can be varied for playing of files of different formats. FIG. 12 shows the media player with the large audio renderer 56 loaded and playing an audio file in a publication having multiple documents. Because the publication has multiple documents, the document chooser 52 is also shown. This version of the document chooser 52 includes textual and picture (thumbnail)-based information about the files in the publication. In contrast, FIG. 13 shows the media player with the small audio renderer 56, and no document chooser 52. This version might be used for a single-document publication containing a single audio file.

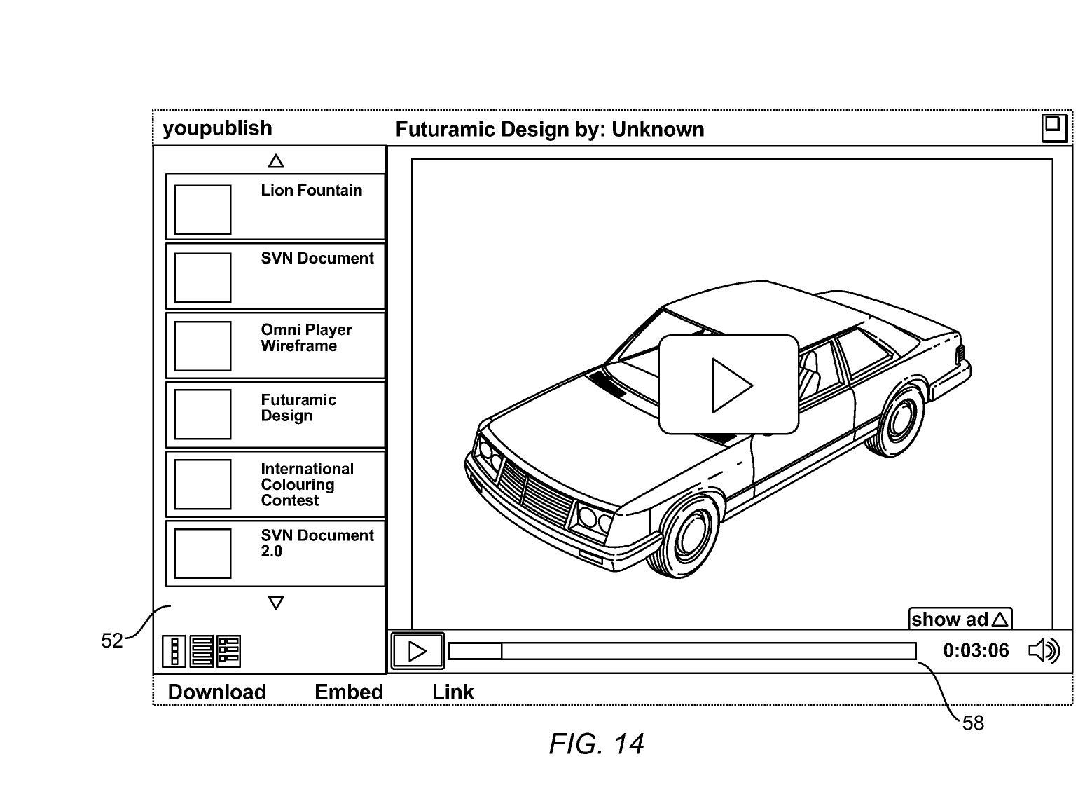

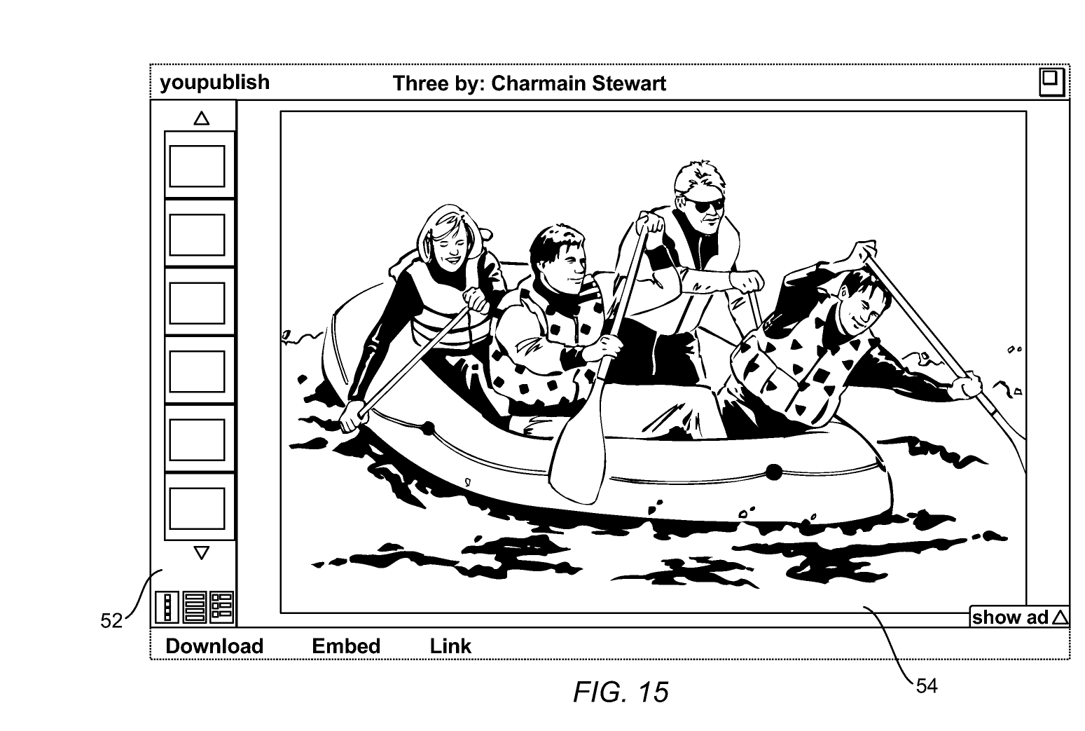

FIG. 14 shows the media player with the video renderer 58 displayed. In this illustration, the document chooser 52 is the same document chooser 52 illustrated in FIG. 12, but with a different file selected. This shows how files of different types may be played by the same media player. If the document chooser 52 of FIGS. 12 and 14 is compared with the document chooser 52 of FIG. 15, some differences become apparent. In FIG. 15, the media player is shown with the image renderer 54 loaded. The publication shown may be an image-only publication, therefore, the textual information shown in the other document choosers 52 has been omitted in favor of pictorial information only. This illustrates at least one way how the document chooser 52 can be varied between implementations.

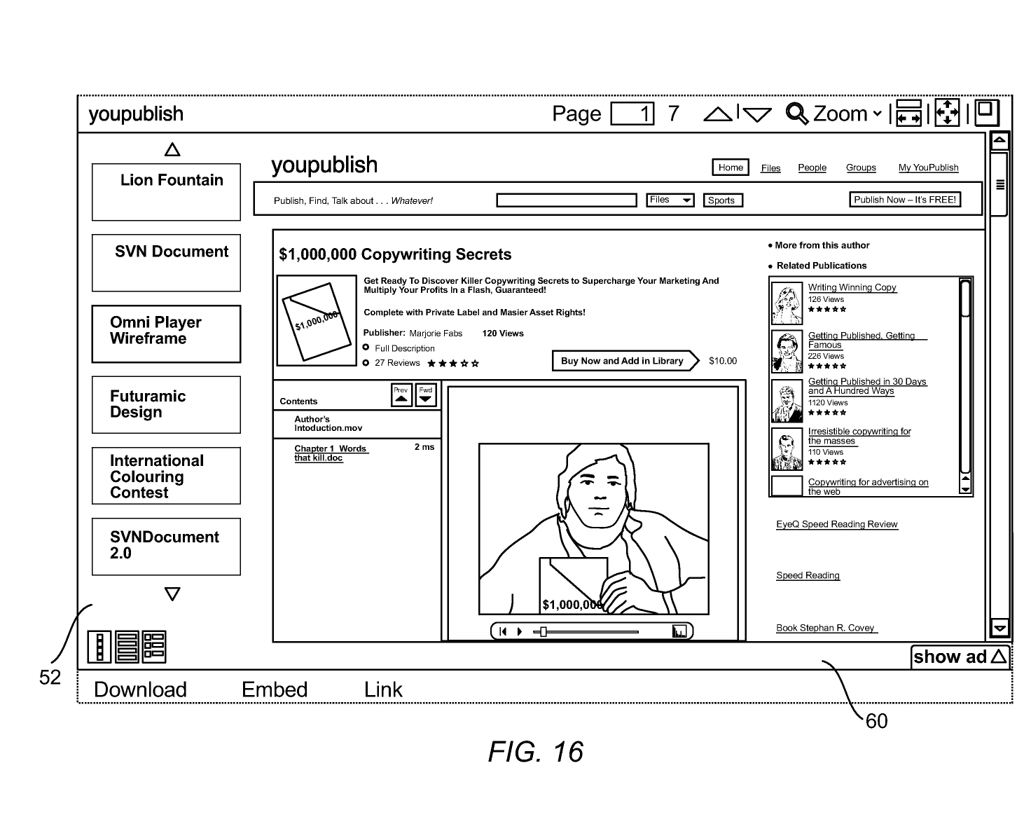

FIG. 16 shows the media player with the document viewer 60 displayed. Again, the document chooser 52 is different, in that it does not show any visual depiction of the various files in the publication. Instead, the document chooser 52 only shows file names or other textual descriptions of the various documents.

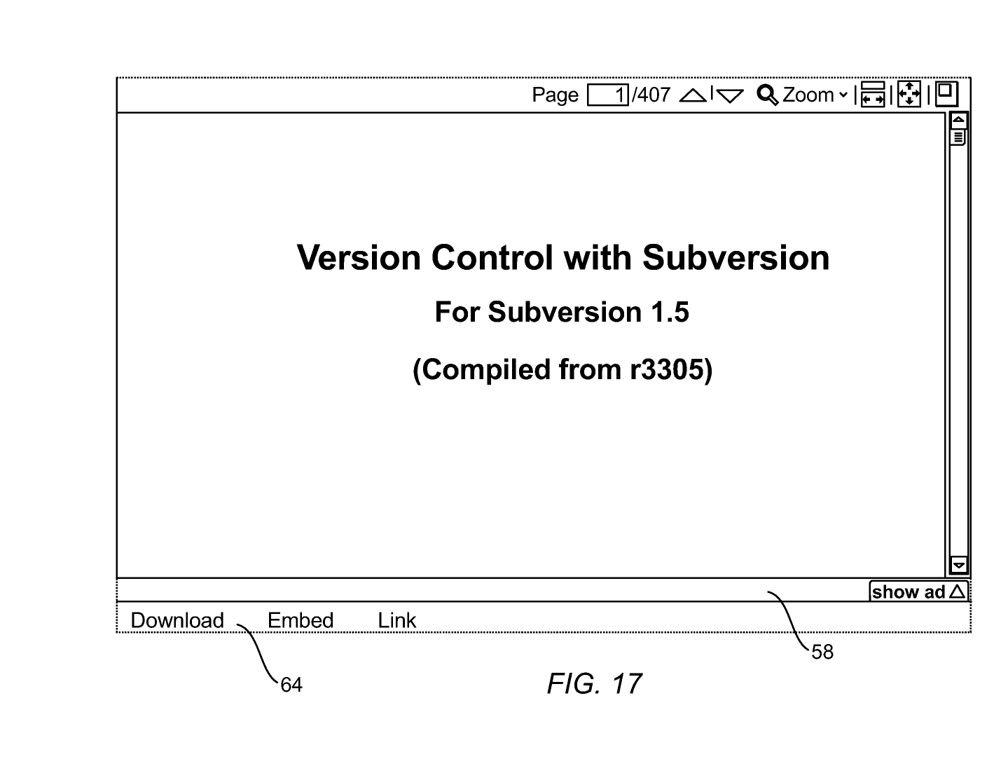

FIG. 17 shows a single-document publication, which is a publication containing only one document. In this situation, the media player determined that it had no need to load a document chooser 52, so the only component loaded into the Omni Player is the renderer component that is capable of displaying the content, in this case the document viewer 60 to play a text-type document. Other examples of single-document publications include publications containing a single song, a single video, or a single image.

Although the media player has been described above with respect to various renderer components, e.g. the image renderer 54, the audio renderer 56, the video renderer 58, and the document viewer 60, it will be appreciated that any type of renderer component may be provided. In addition, multiple renderers of any one type may be provided to handle different formats of one file type. For example, there are many types of audio (e.g. mp3, wave, etc.), picture (e.g. jpg, tiff, gif, etc.), or video files (e.g. mp4, avi, etc.), and many types of documents (PDF, Word, spreadsheet, etc.). The media player may have renderer components designed to play each of these different types of file or a number of these types of files. Alternatively, in some embodiments of the media player, only a limited number of renderer components may be provided, and files that are to be included in publications are converted to a limited number of file types compatible with the limited number of renderer components. Embodiments of the invention embrace both methods of dealing with the large numbers of file types available, including future file types, as well as embracing hybrid approaches where some file types are converted but a larger number of renderer components are available so fewer file types need conversion.

In at least some embodiments, each publication has an author, a name, a description, a uniform resource locator (URL) that points to the webpage where the publication can be viewed, and a URL that points to a zipped version of the entire publication. The user can be allowed in some instances to download the entire publication from the provided URL. As discussed above, some publications are comprised of a set of documents all of the same type (such as a photo album publication of images or a music album publication of mp3 files). Other publications are comprised of documents of different types (like a set of mp3s followed by a text document containing song lyrics).

A single publication has a list of “child” documents from which it is comprised. Each child document has its own attributes, such as: a document name, description, document thumbnail, a URL from which the document (not the entire publication) can be downloaded, and a list of one or more files forming the document. Audio, video, and image documents are commonly only formed of a single file. In some embodiments, text documents can include a number of 100-page “blocks,” all of which add up to being the content for that one text document.

When an end user creates a publication, the end user may be led through the process so that the end user does not think about all of these individual attributes of the publication. Some of these attributes, such as thumbnail images and URLs, are generated by back end software. Whether attributes of a publication (and its child documents) were entered by a user or were system-generated, they completely identify and describe the publication to the back end software and to the media player through which users can view a publication.

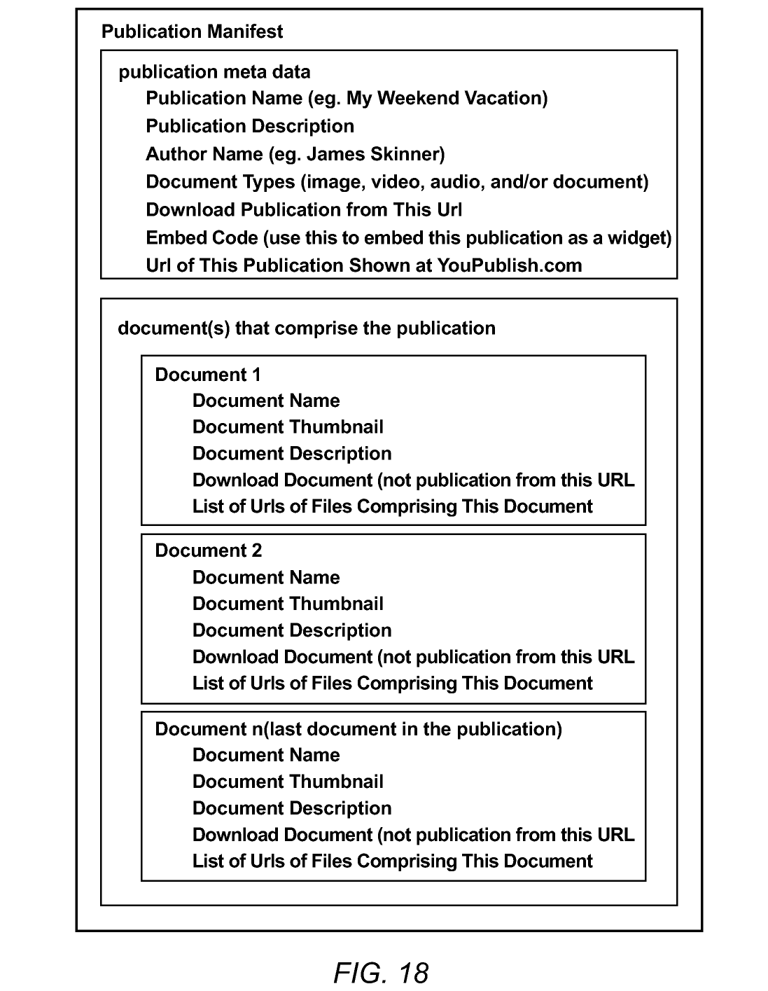

The complete set of data describing a publication is known as a “publication manifest,” which is illustrated in graphic form in FIG. 18. Each time a web page that contains the media player is loaded into a user's browser, the media player reads information (e.g. Flash variables that may be part of its “embed” code) provided to the instance of the media player. That information contains a unique “publication identifier.” The media player then makes a REST call to the back end asking the back end for the publication manifest for the publication that is supposed to be displayed through the media player.

Once the media player has received the publication manifest, it learns about what types of documents it will be rendering/showing, what are the list of documents that form the publication, who was the author of the publication, etc. With all of this information in hand, the media player begins to dynamically load its constituent parts onto the stage 66 available within the browser and then soon shows the end user the first (or only) document within the publication.

While FIG. 18 shows a graphical depiction of a publication manifest, the following is an example of a publication manifest described in the “XML” computer language. This example shows roughly the format of the publication manifest as it would be transmitted over the Internet from the back end into the media player running in someone's browser.

```
<publication id=“omni”>
  <metaData>
    <publicationName>Multi Type Publication</publicationName>
    <authorName>Scott Williams</authorName>
    <documentTypes>document audio video image</documentTypes>
  <downloadUrl>http://www.frisbeefish.com/youpublish/stereolab.jpg</downloadUrl>
  <markAsFavoriteUrl>http://www.frisbeefish.com/youpublish/markasfavorite.php</mark
AsFavoriteUrl>
    <flagUrl>http://www.frisbeefish.com/youpublish/flag.php</flagUrl>
    <embedCode>
    <[CDATA[<object width=“680” height=“440”><param name=“movie”
value=“omniplayer.swf”><param name=“FlashVars”
value=“publicationId=omni”></param><param name=“allowFullScreen”
value=“true”></param><param name=“allowscriptaccess” value=“always ”></param><embed
src=“omniplayer.swf” type=“application/x-shockwave-flash” FlashVars=“publicationId=omni”
allowscriptaccess=“always” allowfullscreen=“true” width=“680”
height=“440”></embed></object>]]>
    </embedCode>
  <linkToOriginalContext>http://www.youpublish.com/files/21115</linkToOriginalContext>
  </metaData>
<documentList>
  <document id=“1” author=“Scott Williams” type=“image” name=“Lion Fountain”
description=“this is the description” album=“Radio 1 Sessions” >
<thumbnail>http://www.frisbeefish.com/scott/projectImages/LandscapeOne_thumb.jpg</thumbnail>
<downloadUrl>http://www.frisbeefish.com/scott/projectImages/LandscapeOne.jpg</downloadUrl>
    <files>
<file>http://www.frisbeefish.com/scott/projectImages/LandscapeOne.jpg</file>
    </files>
  </document>
  <document id=“2” author=“SVN Corp” type=“document” name=“SVN Document”
description=“this is the description” album=“Books” >
    <thumbnail>http://www.frisbeefish.com/youpublish/vidthumb1.jpg</thumbnail>
<downloadUrl>http://www.frisbeefish.com/youpublish/SomethoughtsonNetworking.pdf</downloadUrl>
    <files>
      <file>http://www.frisbeefish.com/youpublish/svn-book.pdf.swf</file>
      <file>http://www.frisbeefish.com/youpublish/svn-book.pdf.swf.2.swf</file>
      <file>http://www.frisbeefish.com/youpublish/svn-book.pdf.swf.3.swf</file>
      <file>http://www.frisbeefish.com/youpublish/svn-book.pdf.swf.4.swf</file>
      <file>http://www.frisbeefish.com/youpublish/svn-book.pdf.swf.5.swf</file>
    </files>
  </document>
  <document id=“3” author=“Matt” type=“document” name=“Omni Player Wireframe”
description=“this is the description” album=“Books” >
    <thumbnail>http://www.frisbeefish.com/youpublish/vidthumb1.jpg</thumbnail>
<downloadUrl>http://www.frisbeefish.com/youpublish/SomethoughtsonNetworking.pdf</downloadUrl>
    <files>
      <file>http://www.frisbeefish.com/youpublish/wireframe.swf</file>
    </files>
  </document>
  <document id=“4” author=“Unknown” type=“video” name=“Futuramic Design”
description=“this is the description” album=“Prelinger Archives” >
    <thumbnail>http://www.frisbeefish.com/youpublish/vidthumb4.jpg</thumbnail>
<downloadUrl>http://www.frisbeefish.com/youpublish/OldsMinu1948_512kb.flv</downloadUrl>
    <files>
      <file>http://www.frisbeefish.com/youpublish/OldsMinu1948_512kb.flv</file>
    </files>
  </document>
  <document id=“5” author=“Stereolab” type=“audio” name=“International Colouring Contest”
description=“this is the description” album=“Radio 1 Sessions” >
    <thumbnail>http://www.frisbeefish.com/youpublish/vidthumb1.jpg</thumbnail>
<downloadUrl>http://www.frisbeefish.com/youpublish/01_International_Colouring_Contest.mp3</downloadUrl>
    <files>
<file>http://www.frisbeefish.com/youpublish/01_International_Colouring_Contest.mp3</file>
    </files>
  </document>
  <document id=“6” author=“SVN Corp” type=“document” name=“SVN Document 2.0”
description=“this is the description” album=“Books” >
    <thumbnail>http://www.frisbeefish.com/youpublish/vidthumb1.jpg</thumbnail>
<downloadUrl>http://www.frisbeefish.com/youpublish/SomethoughtsonNetworking.pdf</downloadUrl>
    <files>
      <file>http://www.frisbeefish.com/youpublish/svn-book.pdf.swf</file>
      <file>http://www.frisbeefish.com/youpublish/svn-book.pdf.swf.2.swf</file>
      <file>http://www.frisbeefish.com/youpublish/svn-book.pdf.swf.3.swf</file>
      <file>http://www.frisbeefish.com/youpublish/svn-book.pdf.swf.4.swf</file>
      <file>http://www.frisbeefish.com/youpublish/svn-book.pdf.swf.5.swf</file>
    </files>
  </document>
</documentList>
</publication>
```

The foregoing XML code is provided only as an example of one way of potentially coding a publication manifest. Other methods and ways of providing a publication manifest or of otherwise providing information to the media player are embraced by embodiments of the invention.

As discussed above, the media player provides faster and more convenient access to files, as it only downloads and loads those components that are necessary for viewing a particular file and/or publication. This shortens the download time before viewing occurs, while still permitting files of different types to be viewed in a single media player.

In some instances, the media player may determine that additional bandwidth beyond what is necessary for playing of a currently-played file is available. The media player may further determine that additional renderer components would be necessary for playing other files in the publication being accessed, or that other files to be accessible have not yet been downloaded. In such instances, some embodiments of the media player may utilize the extra bandwidth to pre-download the additional renderer components and/or the other files to further improve the user experience by minimizing delays encountered when switching between files of different types. Where a pre-download has occurred, and a file of a different type is selected, the media player does not need to download a new renderer component and/or file, but merely hides the previous renderer component and shows the new renderer component and/or file.

Thus, embodiments of the invention provide a media player for playing files of different formats on demand using a plurality of renderer components appropriate for the different formats for a network-connected computer system or electronic device having a visual display. The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. In a network-connected computer system or electronic device having a visual display, a media player for playing files of different formats on demand using a plurality of renderer components appropriate for the different formats comprising:
a media player shell having a viewable stage area displayed on the visual display for playing media and for displaying any controls for controlling playing of media, the shell being configured to determine a file format of one or more files to be played by the media player and to download a first renderer component capable of playing the file format; and
the first renderer component, being one of a plurality of downloadable renderer components, each configured for providing access to a different file format, the first renderer component being downloaded by the shell on demand and displayed on the stage area.

2. A media player as recited in claim 1, wherein the shell is configured to receive a manifest informing the shell of information related to playing of the one or more files to be played by the media player, the information comprising:
a number of files to be made available for playing in the media player; and
the file format or formats of each of the number of files.

3. A media player as recited in claim 2, wherein when the number of files is greater than one, the media player further comprises a document chooser downloaded by the shell and displayed in the stage area to permit a user to select among the files for playing by the media player.

4. A media player as recited in claim 3, wherein the document chooser is varied according to the file formats of the files available for playing.

5. A media player as recited in claim 3, wherein the document chooser contains information to assist the user in selecting a desired file for playing.

6. A media player as recited in claim 3, wherein the first renderer component is downloaded at the time of receiving a selection of a first selected file for playing from a user through the document chooser based on the file format of the selected file.

7. A media player as recited in claim 6, further comprising a second renderer component downloaded for playing a file format of a second selected file for playing, the second renderer component being displayed on the stage area during playing of the second selected file.

8. A media player as recited in claim 7, wherein the first and second renderer components comprise two or more of the following:
audio renderer components;
video renderer components;
image renderer components;
textual renderer components; and
document viewer components.

9. A media player as recited in claim 7, wherein when the second renderer component is being displayed, the first renderer component is hidden but locally available for re-display on the stage area.

10. A media player as recited in claim 1, wherein the media player is embedded in a webpage and displayed by a browser.

11. A media player as recited in claim 1, wherein the first renderer component comprises one or more user-selectable controls for controlling playing of media by the first renderer component.

12. A media player as recited in claim 1, wherein the plurality of downloadable renderer components comprise one or more user-selectable controls for controlling playing of media using the renderer components.

13. A media player as recited in claim 1, wherein the system is configured to output an embed code that allows the player to be embedded in one or more web sites such that a plurality of files associated with the player can be accessed from the embedded player.

14. A media player as recited in claim 1, wherein the system is configured to output an embed code that allows the player to be embedded in one or more web sites such that a plurality of files associated with the player that are of different formats can be accessed from the embedded player.

15. A computer-readable medium storing computer program instructions for implementing a method for providing a media player for playing files of different formats on demand using a plurality of renderer components capable of playing the different formats, the method comprising:
providing a media player shell displayed on a visual display of a network-connected computer system or electronic device, the shell having a viewable stage area for playing media and for displaying any controls for controlling playing of media;
using a manifest to provide the shell information related to playing of one or more files to be played by the media player, the information comprising:
a number of files to be made available for playing in the media player; and
the file format or formats of each of the number of files determining a first file format of a first file to be played by the media player;
downloading a first renderer component capable of playing the first file format;
displaying the first renderer component on the stage area; and
playing the first file using the first renderer component.

16. A computer-readable medium as recited in claim 14, wherein the method further comprises:
determining that more than one file is to be made available for playing in the media player;
downloading a document chooser configured to permit user selection among the files for playing; and
displaying the document chooser on the stage area.

17. A computer-readable medium as recited in claim 15, wherein the method further comprises:
receiving a selection of a second file for playing;
determining a second file format of the second file, wherein the second file format differs from the first file format;
downloading a second renderer component capable of playing the second file format;
displaying the second renderer component on the stage area; and
playing the second file using the second renderer component.

18. A computer-readable medium as recited in claim 16, wherein the method further comprises:
hiding the first renderer component from the stage area upon display of the second renderer component;
receiving a selection of a file having the first file format for playing by the media player;
hiding the second renderer component from the stage area and re-displaying the first renderer component on the stage area; and
playing the selected file using the first renderer component.

19. A computer-readable medium as recited in claim 17, wherein the first renderer component is not re-downloaded, but is locally stored while hidden.

20. A computer-readable medium as recited in claim 14, wherein all components of the media player and all files played by the media player are downloaded over a network on demand.

21. In a network-connected computer system or electronic device having a visual display, a method for providing a media player for playing files of different formats on demand using a plurality of renderer components capable of playing the different formats, the method comprising:
providing a media player shell displayed on a visual display of a network-connected computer system or electronic device, the shell having a viewable stage area for playing media and for displaying any controls for controlling playing of media;
using a manifest to provide the shell information related to playing of one or more files to be played by the media player, the information comprising:
a number of files to be made available for playing in the media player; and
the file format or formats of each of the number of files determining a first file format of a first file to be played by the media player;
downloading a first renderer component capable of playing the first file format;
displaying the first renderer component on the stage area; and
playing the first file using the first renderer component.

22. A method as recited in claim 20, further comprising:
determining that more than one file is to be made available for playing in the media player;
downloading a document chooser configured to permit user selection among the files for playing; and
displaying the document chooser on the stage area.

23. A method as recited in claim 21, further comprising:
receiving a selection of a second file for playing;
determining a second file format of the second file, wherein the second file format differs from the first file format;
downloading a second renderer component capable of playing the second file format;
hiding the first renderer component from the stage area;
displaying the second renderer component on the stage area; and
playing the second file using the second renderer component.

24. A method as recited in claim 21, wherein more than one files have multiple file formats, the method further comprising:
determining a second file format of a second file to be played by the media player; and
downloading a second renderer component capable of playing the second file format, wherein the second renderer component is downloaded before the second file has been selected for playing.

25. A method as recited in claim 23, wherein the second renderer component is downloaded while the first file is playing.

26. A method as recited in claim 23, wherein all renderer components for playing the the multiple file formats of the more than one files are downloaded prior to playing the first file.
